(19) United States
(12) Patent Application Publication
(10) Pub. No.: US 2025/0031065 A1
(43) Pub. Date: Jan. 23, 2025

(54) MACHINE-LEARNING AGENT PARAMETER INITIALIZATION IN WIRELESS COMMUNICATION NETWORK

(71) Applicant: NOKIA SOLUTIONS AND NETWORKS OY, Espoo (FI)

(72) Inventors: István Zsolt KOVÁCS, Aalborg (DK); Muhammad Majid BUTT, Naperville, IL (US); Jian SONG, Palaiseau (FR); Klaus Ingemann PEDERSEN, Aalborg (DK)

(21) Appl. No.: 18/710,244

(22) PCT Filed: Dec. 15, 2022
(86) PCT No.: PCT/EP2022/086087

§ 371 Date: May 15, 2024

(30) Foreign Application Priority Data
Dec. 16, 2021 (FI) 20216284

(51) Int. Cl. H04W 24/02; H04L 41/16

(52) U.S. Cl. CPC H04W 24/02; H04L 41/16

(57) ABSTRACT

The present disclosure relates to a machine-learning (ML) orchestrator entity that provides distributed, flexible, and efficient parameter initialization for ML agents installed on network nodes operating under similar radio conditions. For this end, the ML orchestrator entity instructs two or more of the network nodes to run two or more ML agents in a training mode, which results in generating two or more sets of parameters. Then, the ML orchestrator entity uses the sets of parameters to derive a common set of parameters for the network nodes. The common set of parameters is to be used in an inference mode of the ML agent at each of the network nodes. The transmission of the common set of parameters to the network nodes may be subsequently initiated by the ML orchestrator entity itself or by each of the network nodes independently.

### TECHNICAL FIELD

The present disclosure relates generally to the field of wireless communications, and particularly to techniques for initializing sets of parameters for machine-learning (ML) agents installed on network nodes in a wireless communication network.

### BACKGROUND

There are multiple examples of Machine Learning (ML) algorithms for a wireless communication network (e.g., a Next-Generation Radio Access Network (NG-RAN)) which offer various Radio Resource Management (RRM) improvements. One of such ML algorithms is a Reinforcement Learning (RL) algorithm that, for example, provides a high-efficiency low-complexity mechanism for solving the problem of uplink transmit power control (TPC) parameter optimization for different user equipment (UE) clusters within a serving cell. However, such an RL-based solution typically relies on a set of input parameters which must be chosen carefully to obtain the best performance of the RL algorithm. In general, the prior art ML/RL-based solutions do not explain how to provide the most efficient initialization of ML/RL algorithm parameters.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that enables efficient parameter initialization among ML agents used in a wireless communication network.

The objective above is achieved by the features of the independent claims in the appended claims. Further embodiments and examples are apparent from the dependent claims, the detailed description and the accompanying drawings.

According to a first aspect, an ML orchestrator entity in a wireless communication network is provided. The ML orchestrator entity comprises at least one processor and at least one memory. The at least one memory comprises a computer program code. The at least one memory and the computer program code are configured to, with the at least one processor, cause the ML orchestrator entity to operate at least as follows. At first, the ML orchestrator entity is caused to group a set of network nodes present in the wireless communication network into at least one node cluster based on at least one radio condition of a set of cells served by the set of network nodes. Each network node from the set of network nodes has an ML agent installed thereon. The ML agent is configured to run based on radio measurements in a training mode and an inference mode. Further, the ML orchestrator entity is caused to perform the following operations in respect of each node cluster from the at least one node cluster. The ML orchestrator entity transmits, to at least two network nodes of the node cluster, an indication to obtain a set of parameters for the ML agent by running the ML agent in the training mode. Then, the ML orchestrator entity receives the set of parameters from each of the at least two network nodes of the node cluster and, in response, generates a common set of parameters that is suitable for the inference mode of the ML agents within the node cluster. By combining the training results (i.e., sets of parameters) from the network nodes of the same node cluster, the ML orchestrator entity may provide parameter initialization and re-initialization for the ML agents installed on these network nodes in a distributed, flexible, and efficient manner. Furthermore, the common set of parameters obtained by the ML orchestrator entity for the same node cluster is robust in the sense that it is less impacted by the radio condition(s) experienced by each specific network node of the node cluster. On top of that, the ML orchestrator entity thus configured may deal with any type of ML agents, including those based on deep RL and/or convolutional neural network (CNN)/deep NN (DNN).

In one example embodiment of the first aspect, the at least one memory and the computer program code are configured to, with the at least one processor, cause the ML orchestrator entity to receive the set of parameters from each of the at least two network nodes of the node cluster via an ML agent-specific signalling interface. By doing so, the ML orchestrator entity may be provided with the set of parameters from a specific network node in a fast, reliable, and efficient manner.

In one example embodiment of the first aspect, the at least one memory and the computer program code are further configured to, with the at least one processor, cause the ML orchestrator entity to transmit a request for the set of parameters to each of the at least two network nodes of the node cluster and, in response to the request, receive the set of parameters from each of the at least two network nodes of the node cluster. By doing so, the ML orchestrator entity itself may initiate the transmission or signalling of the sets of parameters from the network nodes of the same node cluster.

In one example embodiment of the first aspect, the at least one memory and the computer program code are further configured to, with the at least one processor, cause the ML orchestrator entity to transmit the common set of parameters to each network node of the node cluster after the common set of parameters is generated. In this example embodiment, the ML orchestrator entity may itself initiate the transmission of the common set of parameters, which may be useful in some applications.

In one example embodiment of the first aspect, the at least one memory and the computer program code are configured to, with the at least one processor, cause the ML orchestrator entity to transmit the common set of parameters to at least one network node of the node cluster in response to a request for the common set of parameters from each of the at least one network node of the node cluster. In this example embodiment, the transmission or signalling of the common set of parameters may be initiated by each network node independently, which may be also useful in some applications.

In one example embodiment of the first aspect, the at least one memory and the computer program code are further configured to, with the at least one processor, cause the ML orchestrator entity to transmit, together with the common set of parameters, a time instant from which the common set of parameters is to be used in the inference mode. By doing so, the ML orchestrator entity may schedule when the network nodes of the same node cluster should start using the common set of parameters (e.g., the use of the common set of parameters at each network node of the same node cluster may be postponed for a certain period of time, if required).

In one example embodiment of the first aspect, the at least one memory and the computer program code are configured to, with the at least one processor, cause the ML orchestrator entity to generate the common set of parameters by using at least one of a linear function, a non-linear function, and a Boolean function. By using these functions, the ML orchestrator entity may properly generate the common set of parameters.

In one example embodiment of the first aspect, the ML agent is an RL agent configured to run in an exploration mode as the training mode and in an exploitation mode as the inference mode. Thus, the ML orchestrator entity may, for example, be efficiently used for solving the problem of RL-based uplink TPC parameter optimization for different UE clusters within a serving cell.

In one example embodiment of the first aspect, the RL agent is based on a Q-learning approach, and the set of parameters from each of the at least two network nodes of the node cluster is presented as a Q-table. In this example embodiment, the at least one memory and the computer program code are configured to, with the at least one processor, cause the ML orchestrator entity to generate the common set of parameters as a common Q-table. By using Q-tables, it is possible to solve the problem of RL-based uplink TPC parameter optimization more efficiently.

According to a second aspect, a method for operating an ML orchestrator entity in a wireless communication network is provided. The method starts with the step of grouping a set of network nodes present in the wireless communication network into at least one node cluster based on at least one radio condition of a set of cells served by the set of network nodes. Each network node from the set of network nodes has an ML agent installed thereon. The ML agent is configured to run based on radio measurements in a training mode and an inference mode. Further, the method proceeds to the following steps which are to be performed independently for each node cluster from the at least one node cluster. The ML orchestrator entity transmits, to at least two network nodes of the node cluster, an indication to obtain a set of parameters for the ML agent by running the ML agent in the training mode. The set of parameters from each of the at least two network nodes of the node cluster is then received at the ML orchestrator entity. Further, the ML orchestrator generates, based on the set of parameters received from each of the at least two network nodes of the node cluster, a common set of parameters that is suitable for the inference mode of the ML agents within the node cluster. By combining the training results (i.e., sets of parameters) from the network nodes of the same node cluster, it is possible to provide parameter initialization and re-initialization for the ML agents installed on these network nodes in a distributed, flexible, and efficient manner. Furthermore, the common set of parameters obtained for the same node cluster is robust in the sense that it is less impacted by the radio condition(s) experienced by each specific network node of the node cluster. On top of that, the method according to the second aspect may be used for any type of ML agents, including those based on deep RL and/or CNN/DNN).

In one example embodiment of the second aspect, the set of parameters is received from each of the at least two network nodes of the node cluster via an ML agent-specific signalling interface. By doing so, the ML orchestrator entity may be provided with the set of parameters from a specific network node in a fast, reliable, and efficient manner.

In one example embodiment of the second aspect, the set of parameters is received from each of the at least two network nodes of the node cluster in response to a request for the set of parameters which is transmitted from the ML orchestrator entity to each of the at least two network nodes of the node cluster. By doing so, the ML orchestrator entity itself may initiate the transmission or signalling of the sets of parameters from the network nodes of the same node cluster.

In one example embodiment of the second aspect, the method further comprises the step of transmitting the common set of parameters from the ML orchestrator entity to each network node of the node cluster after the common set of parameters is generated. In this example embodiment, the ML orchestrator entity may itself initiate the transmission of the common set of parameters, which may be useful in some applications.

In one example embodiment of the second aspect, the method further comprises the steps of receiving a request for the common set of parameters from at least one network node of the node cluster and, in response to the request, transmitting the common set of parameters from the ML orchestrator entity to each of the at least one network node of the node cluster.

Thus, the transmission or signalling of the common set of parameters may be initiated by each network node independently, which may be also useful in some applications.

In one example embodiment of the second aspect, the method further comprises the step of transmitting, together with the common set of parameters, a time instant from which the common set of parameters is to be used in the inference mode. By doing so, the ML orchestrator entity may schedule when the network nodes of the same node cluster should start using the common set of parameters (e.g., the use of the common set of parameters at each network node of the same node cluster may be postponed for a certain period of time, if required).

In one example embodiment of the second aspect, the common set of parameters is generated by using at least one of a linear function, a non-linear function, and a Boolean function. By using these functions, the ML orchestrator entity may properly generate the common set of parameters.

In one example embodiment of the second aspect, the ML agent is a reinforcement learning (RL) agent configured to run in an exploration mode as the training mode and in an exploitation mode as the inference mode. Thus, the method according to the second aspect may, for example, be efficiently used for solving the problem of RL-based uplink TPC parameter optimization for different UE clusters within a serving cell.

In one example embodiment of the second aspect, the RL agent is based on a Q-learning approach, and the set of parameters from each of the at least two network nodes of the node cluster is presented as a Q-table. In this example embodiment, the common set of parameters is also generated as a common Q-table. By using Q-tables, it is possible to solve the problem of RL-based uplink TPC parameter optimization more efficiently.

According to a third aspect, a computer program product is provided. The computer program product comprises a computer-readable storage medium that stores a computer code. Being executed by at least one processor, the computer code causes the at least one processor to perform the method according to the second aspect. By using such a computer program product, it is possible to simplify the implementation of the method according to the second aspect in any network entity, like the ML orchestrator entity according to the first aspect.

According to a fourth aspect, an ML orchestrator entity in a wireless communication network is provided. The ML orchestrator entity comprises a means for grouping a set of network nodes present in the wireless communication network into at least one node cluster based on at least one radio condition of a set of cells served by the set of network nodes. Each network node from the set of network nodes has an ML agent installed thereon. The ML agent is configured to run based on radio measurements in a training mode and an inference mode. The ML orchestrator entity further comprises one or more means for performing the following steps for each of the at least one node cluster:
transmitting, to at least two network nodes of the node cluster, an indication to obtain a set of parameters for the ML agent by running the ML agent in the training mode;
receiving the set of parameters from each of the at least two network nodes of the node cluster; and
generating, based on the sets of parameters, a common set of parameters that is suitable for the inference mode of the ML agents within the node cluster.

By combining the training results (i.e., sets of parameters) from the network nodes of the same node cluster, the ML orchestrator entity may provide parameter initialization and re-initialization for the ML agents installed on these network nodes in a distributed, flexible, and efficient manner. Furthermore, the common set of parameters obtained by the ML orchestrator entity for the same node cluster is robust in the sense that it is less impacted by the radio condition(s) experienced by each specific network node of the node cluster. On top of that, the ML orchestrator entity thus configured may deal with any type of ML agents, including those based on deep RL and/or CNN/DNN).

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a block diagram of a machine-learning (ML) orchestrator entity in accordance with one example embodiment;

FIG. 2 shows a flowchart of a method for operating the ML orchestrator entity shown in FIG. 1 in accordance with one example embodiment;

FIG. 3 schematically explains how the method shown in FIG. 2 may be used in one possible RL-based scenario;

FIG. 4 schematically explains how the method shown in FIG. 2 may be used in another possible RL-based scenario;

FIG. 5 shows an interaction diagram which explains the interaction between an ML orchestrator entity and two network nodes in a wireless communication network in accordance with one example embodiment; and

FIGS. 6A-6C show simulation results obtained by implementing the method shown in FIG. 2 in a dynamic system-level simulator having 3GPP specification-compliant functionalities.

### DETAILED DESCRIPTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatus and method disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment recited herein as “example embodiment” should not be construed as preferable or having an advantage over other embodiments.

According to the example embodiments disclosed herein, a User Equipment (UE) may refer to an electronic computing device that is configured to perform wireless communications. The UE may be implemented as a mobile station, a mobile terminal, a mobile subscriber unit, a mobile phone, a cellular phone, a smart phone, a cordless phone, a personal digital assistant (PDA), a wireless communication device, a desktop computer, a laptop computer, a tablet computer, a gaming device, a netbook, a smartbook, an ultrabook, a medical mobile device or equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IoT) device, an Industrial IoT (IIoT) device, a machine-type communication (MTC) device, a group of Massive IoT (MIoT) or Massive MTC (mMTC) devices/sensors, or any other suitable mobile device configured to support wireless communications. In some embodiments, the UE may refer to at least two collocated and inter-connected UEs thus defined.

As used in the example embodiments disclosed herein, a network node may refer to a fixed point of communication for a UE in a particular wireless communication network. More specifically, the network node is used to connect the UE to a Data Network (DN) through a Core Network (CN) and may be referred to as a base transceiver station (BTS) in terms of the 2G communication technology, a NodeB in terms of the 3G communication technology, an evolved NodeB (eNodeB) in terms of the 4G communication technology, and a gNB in terms of the 5G New Radio (NR) communication technology. The network node may serve different cells, such as a macrocell, a microcell, a picocell, a femtocell, and/or other types of cells. The macrocell may cover a relatively large geographic area (for example, at least several kilometers in radius). The microcell may cover a geographic area less than two kilometers in radius, for example. The picocell may cover a relatively small geographic area, such, for example, as offices, shopping malls, train stations, stock exchanges, etc. The femtocell may cover an even smaller geographic area (for example, a home). Correspondingly, the network node serving the macrocell may be referred to as a macro node, the network node serving the microcell may be referred to as a micro node, and so on.

According to the example embodiments disclosed herein, a machine-learning (ML) orchestrator entity or, in other words, an ML coordinator (MLC) may refer to an apparatus configured to manage the operation of ML agents installed on different network nodes in a centralized and automatic manner. More specifically, the ML orchestrator entity discussed herein may be efficiently used to initialize and re-initialize parameters for each of the ML agents. The ML orchestrator entity may be implemented as a gNB-Control Unit (gNB-CU) in case of a gNB split architecture (in this example, one or more network nodes may be implemented as one or more gNB-Distributed Units (gNB-DUs)), a Radio Access Network (RAN) Intelligent Controller (RIC), or any CN function (e.g., a Network Data Analytics Function (NWDAF), an Operations, Administration, and Maintenance Function (OAMF), etc.).

As used in the example embodiments disclosed herein, an ML agent may refer to a system that uses a ML-based algorithm to perform one or more network tasks, such, for example, as Radio Resource Management (RRM) (e.g., uplink TPC parameter optimization), UE detection and location, etc. The ML agent may be implemented as a software component installed on a network node in a wireless communication network for the purpose of solving the network tasks.

According to the example embodiments disclosed herein, a wireless communication network, in which an ML orchestrator entity manages the operation of ML agents of network nodes, may refer to a cellular or mobile network, a Wireless Local Area Network (WLAN), a Wireless Personal Area Networks (WPAN), a Wireless Wide Area Network (WWAN), a satellite communication (SATCOM) system, or any other type of wireless communication networks. Each of these types of wireless communication networks supports wireless communications according to one or more communication protocol standards. For example, the cellular network may operate according to the Global System for Mobile Communications (GSM) standard, the Code-Division Multiple Access (CDMA) standard, the Wide-Band Code-Division Multiple Access (WCDM) standard, the Time-Division Multiple Access (TDMA) standard, or any other communication protocol standard, the WLAN may operate according to one or more versions of the IEEE 802.11 standards, the WPAN may operate according to the Infrared Data Association (IrDA), Wireless USB, Bluetooth, or ZigBee standard, and the WWAN may operate according to the Worldwide Interoperability for Microwave Access (WiMAX) standard.

The operational efficiency and the overall cost of operation of a wireless communication network may be reduced by means of network function automation and rational RRM. All of this may be achieved by using ML-based control algorithms in network nodes. The ML-based control algorithms may allow one to simplify and automate complex network tasks, resulting in a more efficient network operation and improved quality of wireless communications.

One critical aspect identified for the ML-based (especially, RL-based) control algorithms is their initialization during the so called ‘warm-up’ period (i.e., during a training mode, also known as a learning phase). However, the existing ML-based control algorithms applied in network nodes do not give details on how to provide the most efficient parameter initialization of the ML-based control algorithms. It is therefore desirable to make such ML-based control algorithms:
(i) robust to dynamically changing radio conditions usually observed in cells of interest-such that they allow for nearly real-time adaptation to new radio conditions, certainly without human intervention;
(ii) capable of providing the same initialization parameters to ML agents installed on network nodes which serve cells with similar radio conditions; and
(iii) easy to execute and reproduce off-line based on previously collected data-such that periodic sanity checks may be performed without compromising the network performance.

The example embodiments disclosed herein provide a technical solution that allows mitigating or even eliminating the above-sounded drawbacks peculiar to the prior art. In particular, the technical solution disclosed herein relates to an ML orchestrator entity that provides distributed, flexible, and efficient parameter initialization for ML agents installed on network nodes operating under similar radio conditions. For this end, the ML orchestrator entity instructs two or more of such network nodes to run two or more ML agents in a training mode, which results in generating two or more sets of parameters. Then, the ML orchestrator entity collects and uses the sets of parameters from said two or more network nodes to derive a common set of parameters for the network nodes. The common set of parameters is to be used in an inference mode of the ML agent at each of the network nodes.

The transmission of the common set of parameters to the network nodes may be subsequently initiated by the ML orchestrator entity itself or independently by each of the network nodes (e.g., in response to a corresponding request from one or more of the network nodes). The proposed configuration of the ML orchestrator entity corresponds to all requirements (i)-(iii) mentioned above.

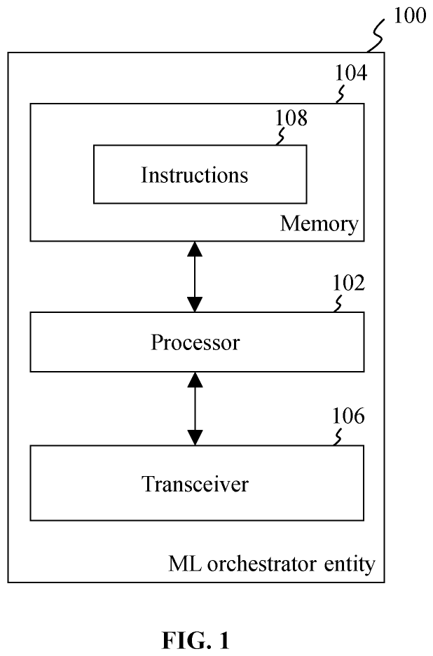

FIG. 1 shows a block diagram of an ML orchestrator entity 100 in accordance with one example embodiment. The ML orchestrator entity 100 is intended to communicate with one or more network nodes in any of the above-described wireless communication networks. As shown in FIG. 1, the ML orchestrator entity 100 comprises a processor 102, a memory 104, and a transceiver 106. The memory 104 stores processor-executable instructions 108 which, when executed by the processor 102, cause the processor 102 to perform the aspects of the present disclosure, as will be described below in more detail. It should be noted that the number, arrangement, and interconnection of the constructive elements constituting the ML orchestrator entity 100, which are shown in FIG. 1, are not intended to be any limitation of the present disclosure, but merely used to provide a general idea of how the constructive elements may be implemented within the ML orchestrator entity 100. For example, the processor 102 may be replaced with several processors, as well as the memory 104 may be replaced with several removable and/or fixed storage devices, depending on particular applications. Furthermore, in some embodiments, the transceiver 106 may be implemented as two individual devices, with one for a receiving operation and another for a transmitting operation. Irrespective of its implementation, the transceiver 106 is intended to be capable of performing different operations required to perform the data reception and transmission, such, for example, as signal modulation/demodulation, encoding/decoding, etc. In other embodiments, the transceiver 106 may be part of the processor 102 itself.

The processor 102 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 102 may be implemented as any combination of one or more of the aforesaid. As an example, the processor 102 may be a combination of two or more microprocessors.

The memory 104 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 108 stored in the memory 104 may be configured as a computer-executable program code which causes the processor 102 to perform the aspects of the present disclosure. The computer-executable program code for carrying out operations or steps for the aspects of the present disclosure may be written in any combination of one or more programming languages, such as Java, C++, or the like. In some examples, the computer-executable program code may be in the form of a high-level language or in a pre-compiled form and be generated by an interpreter (also pre-stored in the memory 104) on the fly.

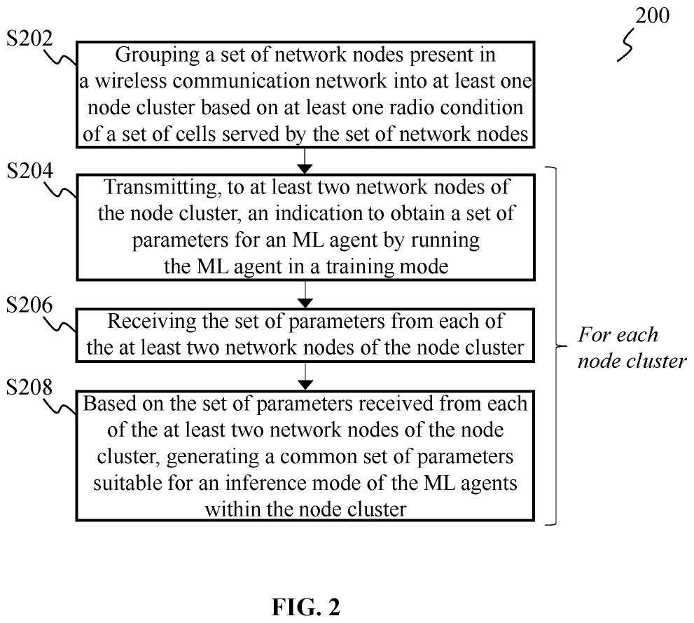

FIG. 2 shows a flowchart of a method 200 for operating the ML orchestrator entity 100 in accordance with one example embodiment.

The method 200 starts with a step S202, in which the processor 102 groups a set of network nodes present in the wireless communication network into one or more node clusters based on one or more radio conditions of a set of cells served by the set of network nodes. For example, the node cluster(s) may be constituted by the network nodes serving the cells which are located within the same geographical area and/or in which the same type of UE traffic is observed. In general, each node cluster may comprise the network nodes corresponding to similar radio conditions of the served cells. It is also assumed that each network node from the set of network nodes has an ML agent installed thereon in advance. Such an ML agent should be configured to run in a training mode and an inference mode based on input data that may be represented by any network data usually used in the existing wireless communication networks. One non-restrictive example of such input data may include different radio measurements (e.g., UE Reference Signal Received Power (RSRP) measurements, UE transmission power measurements, etc.).

Once the node cluster(s) is obtained, the method 200 proceeds to steps S204-S208 which are performed by the processor 102 independently for each node cluster. It should be noted that, in case of two or more node clusters obtained in the step S202, the two or more node clusters may be subjected to the steps S204-S208 in parallel or in sequence, depending on particular applications and/or processor capabilities.

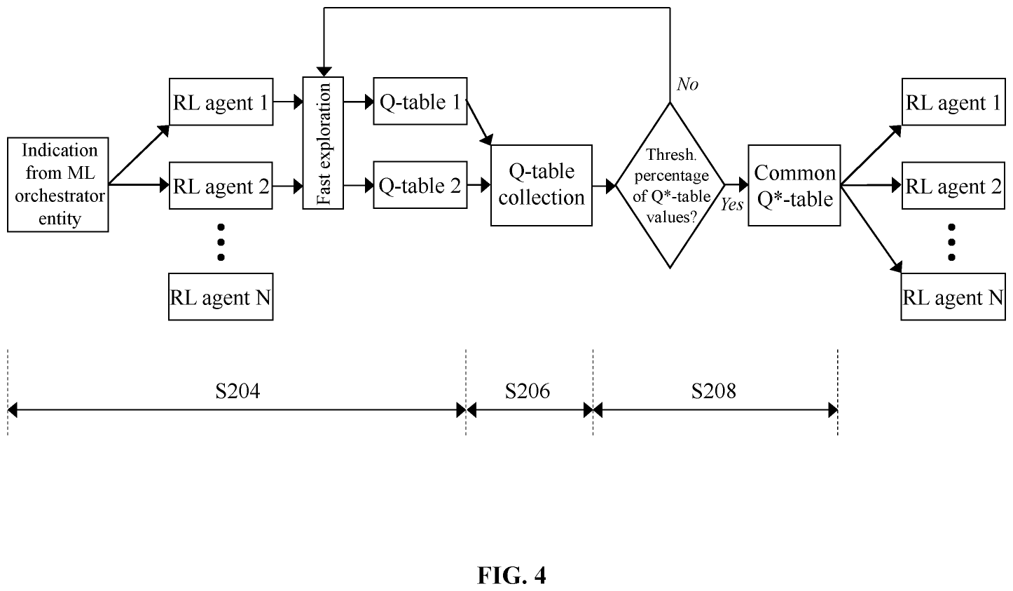

In the step S204, the processor 102 transmits (e.g., via the transceiver 106), to two or more network nodes of the node cluster, an indication to obtain a set of parameters for the ML agent by running the ML agent in the training mode. It should be noted that the processor 102 may determine the network nodes to be provided with such an indication based on different selection criteria. For example, the processor 102 may discard the network nodes of the node cluster which control cells with fewer UEs (e.g., the number of UEs within a cell of interest is less than a threshold). Alternatively or additionally, the processor 102 may discard the network nodes in which a fast exploration condition (which will be discussed later with reference to FIG. 4) for ML agents has not been recently satisfied—it means the processor 102 may only select the ML agents where the fast exploration condition has been satisfied. The indication itself may be transmitted by using a ML agent-specific signalling interface. Such an indication may also comprise training mode characteristics which may be exemplified by at least one of: a learning rate (periodicity), dedicated radio resources to be used during the training mode, and a training duration. The training mode characteristics may be set to be the same for each network node of the node cluster. The training mode execution results in a set of parameters that is indicative of ML agent performance (e.g., any type of Key Performance Indicator (KPI) commonly used in the art) in each network node of the node cluster.

In the step S206, the processor receives (e.g., via the transceiver 106) the set of parameters from each of said two or more network nodes of the node cluster. Each set of parameters may be again received over the ML agent-specific signalling interface. In one example embodiment, each of said two or more network nodes may initiate the transmission or signalling of the set of parameters by itself (e.g., once the set of parameters is generated). In another example embodiment, the transmission or signalling of each set of parameters may be initiated by the ML orchestrator entity 100 (e.g., the processor 102 may transmit a request for the set of parameters to each of the network nodes involved in the step S204 and, in response, receive the sets of parameters; alternatively, the transmission or signalling of the set of parameters from each of the network nodes involved in the step S204 may be initiated in response to a certain trigger event or depending on subscriptions and protocols applied for these network nodes).

In the step S208, the processor 102 generates, based on the set of parameters received from each of the network nodes involved in the step S204, a common set of parameters that is suitable for the inference mode of the ML agents within the node cluster. In some example embodiments, the common set of parameters may be generated by using at least one of a linear function, a non-linear function, and a Boolean function. Some non-restrictive examples of such functions include an averaging function, a weighted sum function, a minimum function (i.e., function MIN ( ), and a maximum function (i.e., function MAX ( ). For example, if the processor 102 receives three sets of parameters from one node cluster in the step S206 (i.e., three network nodes in the node cluster have been instructed to run their ML agents in the training mode), and assuming that each of the three sets of parameters is presented as Sᵢ=(aᵢ, bᵢ, cᵢ), where i=1, 2, 3, the processor 102 may generate the common set of parameters for the node cluster by sequentially computing an average over each of parameters dᵢ, bᵢ, cᵢ for the three set of parameters, thereby generating the following common set of parameters: S*=(a_{average}, b_{average}, c_{average}). Alternatively, the processor 102 may find the lowest or highest value of each of parameters dᵢ, bᵢ, cᵢ among the three set of parameters by using the function MIN ( ) or MAX ( ) respectively, thereby generating the following common set of parameters: S*=(aₘᵢₙ, bₘᵢₙ, cₘᵢₙ) or S*=(aₘₐₓ, bₘₐₓ, cₘₐₓ). At the same time, the processor 102 may use any combination of the above-described and other mathematical functions to generate the common set of parameters (e.g., the processor 102 may use the combination of the functions MIN ( ) and MAX ( ) and the averaging function such that the common set of parameters is as follows: S*=(aₘᵢₙ, bₘₐₓ, c_{average})).

In one example embodiment, the method 200 may comprise an additional step, in which the processor 102 transmits (e.g., via the transceiver 106) the common set of parameters to each network node (i.e., not only those involved in the step S204) of the node cluster after the step S208 of the method 200. The common set of parameters may be again transmitted over the ML agent-specific signalling interface.

In an alternative example embodiment, the transmission or signalling of the common set of parameters may be initiated independently by one or more network nodes of the node cluster. For example, each network node may transmit a corresponding request to the ML orchestrator entity 100 and, in response, receive the common set of parameters.

In one example embodiment, the processor 102 may transmit, together with the common set of parameters, a time instant from which the common set of parameters is to be used in the inference mode. The time instant may be indicated, for example, by using a System Frame Number (SFN) or in accordance with the Coordinated Universal Time (UTC) standard.

In one example embodiment, the ML agent installed on each network node of the node cluster of interest may be a reinforcement learning (RL) agent that is configured to run in an exploration mode as the training mode and in an exploitation mode as the inference mode. Furthermore, such an RL agent may use a well-known Q-learning approach, for which reason the set of parameters generated by each of the instructed network nodes in the step S204 may be presented as a Q-table. The Q-table is a well-known type of a lookup table which comprises values each represented by a combination of a state and an action taken by the RL agent in the state, i.e., Q (state, action). These Q-table is obtained by using a state-action value function which is also well-known in the art and therefore not described herein in detail. The Q-table may serve as an RL agent performance metric which reflects the degree/extent of achieved exploration in each network node. The Q-table may optionally include the actual achieved values Q (state, action) and/or other metrics, such as a number of visits for each value Q (state, action), an averaged reward value after exploration, etc. Moreover, if required, the Q-table values may be normalized using a pre-configured rule (e.g., the normalization may be based on maximum and minimum expected cell throughputs in a given cell (RL agent) during a predefined time period). In this example embodiment, the common set of parameters may be also generated in the step S208 as a common Q*-table which may be formatted in the same manner as the Q-tables from the network nodes. It should be noted that the common Q*-table may be generated by using the same functions as the ones discussed above with reference to the common set S*of parameters.

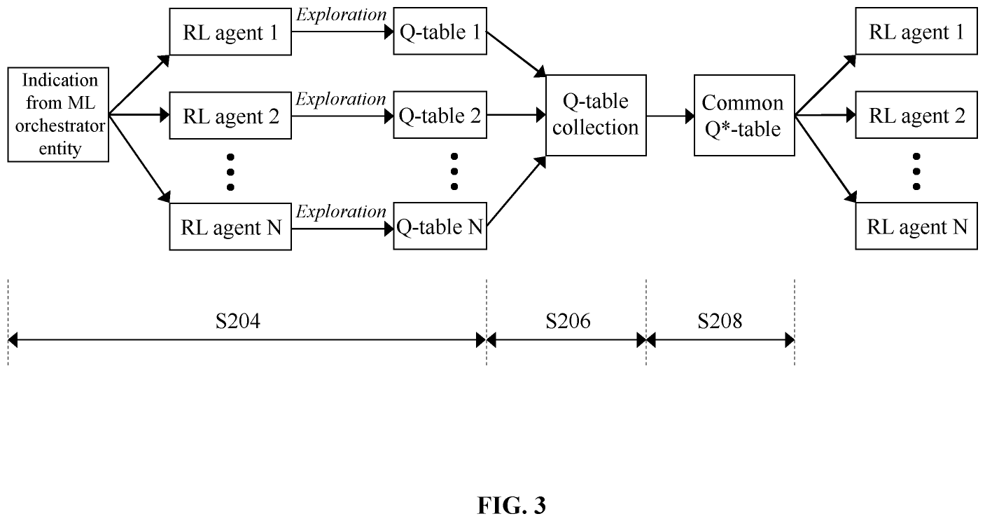

FIG. 3 schematically explains how the method 200 may be used in one possible RL-based scenario. In this RL-based scenario, it is assumed that each ML agent is implemented as an RL agent using the Q-learning approach. It is also assumed that the processor 102 obtains a single node cluster comprising N network nodes in the step S202 of the method 200, whereafter the processor 102 instructs each of the N network nodes to run its RL agent in the exploration mode in the step S204 of the method 200. As a result, the N RL agents generate N Q-tables which are then collected by the processor 102 in the step S206 of the method 200. The processor 102 uses the collected N Q-tables to generate a common Q*-table for the node cluster (e.g., like any of the common Q*-tables discussed above) in the step S208 of the method 200. Subsequently, the processor 102 may itself initiate the transmission of the common Q-table to each of the N network nodes or, in other words, to each of the N RL agents.

FIG. 4 schematically explains how the method 200 may be used in another possible RL-based scenario. In this RL-based scenario, it is again assumed that each ML agent is implemented as an RL agent using the Q-learning approach, and the processor 102 obtains a single node cluster comprising N network nodes in the step S202 of the method 200. However, unlike the RL-based scenario shown in FIG. 3, the RL-based scenario shown in FIG. 4 additionally implies that the processor 102 instructs only two of the N network nodes to run their RL agents in the fast-exploration mode (i.e., with a low RL updating period) in the step S204 of the method 200. As shown in FIG. 4, these two network nodes are first two network nodes in the node cluster-however, this should not be construed as any limitation of the present disclosure, and any number of different network nodes in the node cluster may be used for this purpose in some other possible RL-based scenarios. As a result, the first two RL agents generate two Q-tables which are then collected by the processor 102 in the step S206 of the method 200. The processor 102 uses the collected two Q-tables to generate a common Q*-table for the node cluster (e.g., like any of the common Q*-tables discussed above) in the step S208 of the method 200. Another difference compared to the RL-based scenario shown in FIG. 3 is that the processor 102 may additionally use, in the step S208 of the method 200, a procedure which checks if a sufficient number (e.g., a threshold percentage) of Q*-table values or entries have been obtained based on the collected two Q-tables. In case of “no”, the fast exploration with the selected RL agents (i.e., the steps S204-S208) is executed until such a criterion (e.g., the threshold percentage of Q*-table entries) is met. In case of “yes”, the processor 102 may itself initiate the transmission of the common Q*-table to each of the N network nodes or, in other words, to each of the N RL agents.

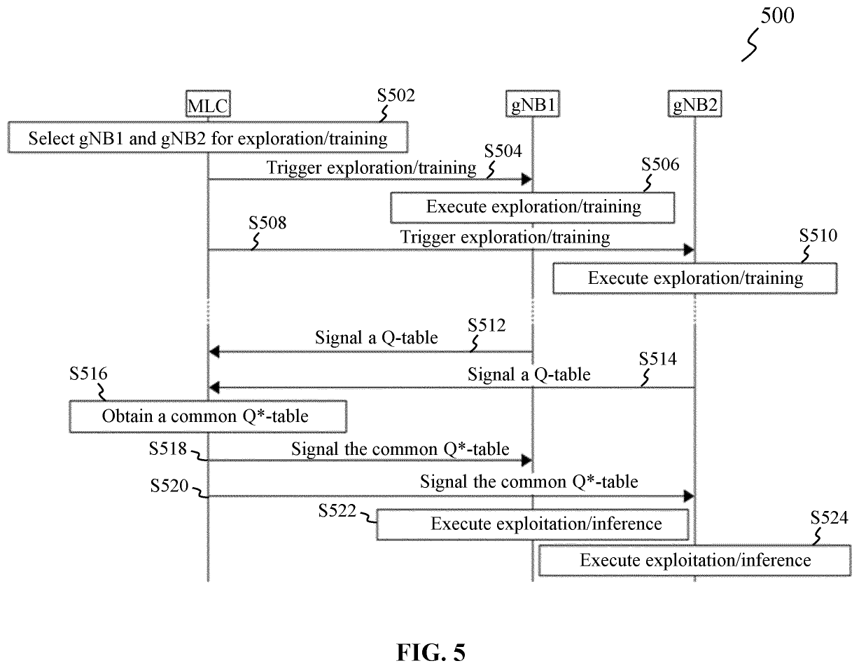

FIG. 5 shows an interaction diagram 500 which explains the interaction between an ML orchestrator entity and two network nodes in a wireless communication network in accordance with one example embodiment. The ML orchestrator entity or, in other words, MLC may be implemented as the ML orchestrator entity 100, and each of the two network nodes is implemented as a gNB, meaning that the interaction diagram 500 is executed in a 5G communication network. The number of the network nodes shown in FIG. 5 is selected for simplicity only and should not be construed as any limitation of the present disclosure. In the interaction diagram 500, it is assumed that there is only one node cluster obtained by the MLC, and the ML agents of the two network nodes (i.e., gNB1 and gNB2) constituting the node cluster are implemented as the RL agents using the Q-learning approach. The interaction diagram 500 starts with a step S502, in which the MLC decides to cause each of gNB1 and gNB2 to run the RL agent in the exploration mode. The MLC transmits a corresponding indication or trigger signal to gNB1 in a step S504, and gNB1 executes the exploration mode of the RL agent in a step S506. Similarly, the MLC transmits the same indication or trigger signal to gNB2 in a step S508, and gNB2 executes the exploration mode of the RL agent in a step S510. It should be noted that the steps S504 and S508 may be performed in parallel, for which reason the execution of the exploration mode in each of gNB1 and gNB2 may be also initiated at the same time. Next, the interaction diagram 500 proceeds to a step S512, in which gNB1 transmits a Q-table obtained in the step S506 to the MLC, and then to a step S514, in which gNB2 transmits a Q-table obtained in the step S510 to the MLC. In a next step S516, the MLC uses the Q-tables from gNB1 and gNB2 to generate a common Q*-table, as discussed earlier. The MLC transmits the common Q*-table to each of gNB1 and gNB2 in steps S518 and S520, respectively. As noted earlier, the transmission of the common Q*-table may be initiated by the MLC itself or each of gNB1 and gNB2 independently by using a node-specific/dedicate signalling procedure. Again, the steps S518 and S520 may be performed in parallel, if required. The interaction diagram 500 ends with steps S522 and S524, in which gNB1 and gNB2, respectively, run their RL agents in the exploitation mode by using the common Q*-table. The exploitation mode may be used to solve a certain network task (e.g., uplink TPC parameter optimization).

### Simulation Results

The proposed configuration of the ML orchestrator entity 100 and its operation method (i.e., the method 200) have been implemented in a dynamic system-level simulator with 3GPP specification-compliant functionalities.

As a proof-of-concept example for the method 200, the classical Q-learning algorithm has been used. More specifically, the online intra-RAN Q-learning algorithm has been used to solve the problem of uplink (UL) TPC parameter optimization for different UE clusters (obtained based on UE RSRP measurements). After a certain period of exploration, N independent Q-tables are generated for each cell or, in other words, each network node (gNB). Such Q-tables may comprise different Key Performance Indicators (KPIs). By using the method 200, a common Q*-table has been obtained for optimal parameter initialization in each RL agent. The system simulation parameters are described in Table 1, while the Q-learning parameters are described in Table 2.

TABLE 1
System simulation parameters

| Parameter | Description/Value |
|---|---|
| Environment | 3GPP compliant 21 sites - Base Stations (BS) |
| | (N = 21), 3-sector Urban Macro (UMa) |
| | cellular with 200 m ISD, 3D UMa channel |
| | model, Frequency-Division Duplexing (FDD) |
| | and Uplink transmission |
| PHY numerology | 20 MHz carrier bandwidth at 3.5 GHz, 30 kHz |
| | sub carrier spacing, Transmission Time |
| | Interval (TTI) size of 14 Orthogonal Frequency |
| | Division Multiplexing (OFDM) symbols |
| Packet scheduler | Time domain (TD): Propotional Fair, |
| | Frequency domain (FD): Adaptive |
| | Transmission Bandwidth (ATB) |
| Link adaptation | Dynamic link adaptation, Outer Loop Link |
| | Adaptation (OLLA) algorithm with 1% Block |
| | Error Rate (BLER) target; Range of Modulation |
| | Coding Scheme (MCS) values: QPSK1to8 - |
| | 64QAM9to10 |
| Antenna configuration | 1 × 2 single user single stream Multiple Input |
| | Multiple Output (MIMO) and Minimum Mean |
| | Square Error - Interference Rejection |
| | Combining (MMSE-IRC) receiver |

TABLE 2
Q-learning algorithm parameters

| Parameter | Description/Value |
|---|---|
| System-level simulator | Simulator steps: 28000 steps/second, warm- |
| steps | up until 2800 steps, last step number 560000 |
| | (20 seconds in total) |
| Q-learning steps | Fast exploration mode with 0.01 seconds |
| | period (Q-learning steps = 0.01*28000 |
| | simulator steps), the full range of 20 s for |
| | exploration |
| RSRP difference threshold | 4 dB (2 clusters) |
| for separating UE clusters | |
| P0 cluster 0 (cell-edge) | Controlled by Q-learning |
| P0 cluster 1 (cell-center) | P₀ = −90 dBm |
| Reward function weight | 0.4 (Optimized from manual P0 test) |
| State space (range of P0) | [−120 dBm, −60 dBm] with resolution 1 dB |
| Action (P0 adjustment) | 1 dB |
| Q-learning parameters | Learning rate β = 0.7, discounting factor |
| | γ = 0.95, exploration probability 0.9 |
| Initial Q value | 250000 for all the Q(s, a) entries, same for |
| | all 21 BS Q-tables |

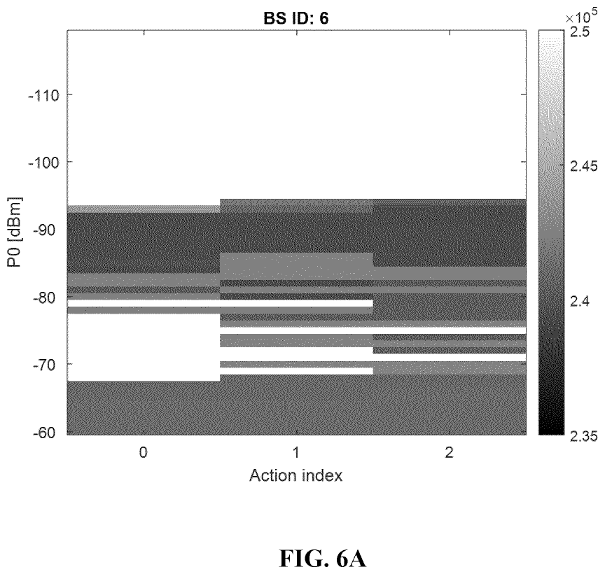

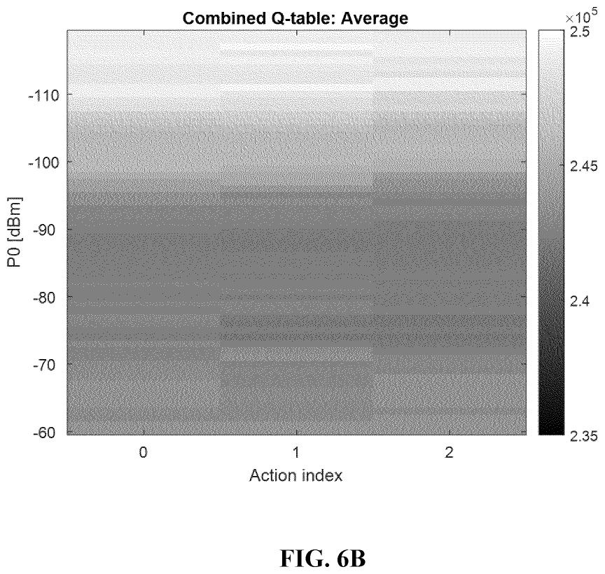

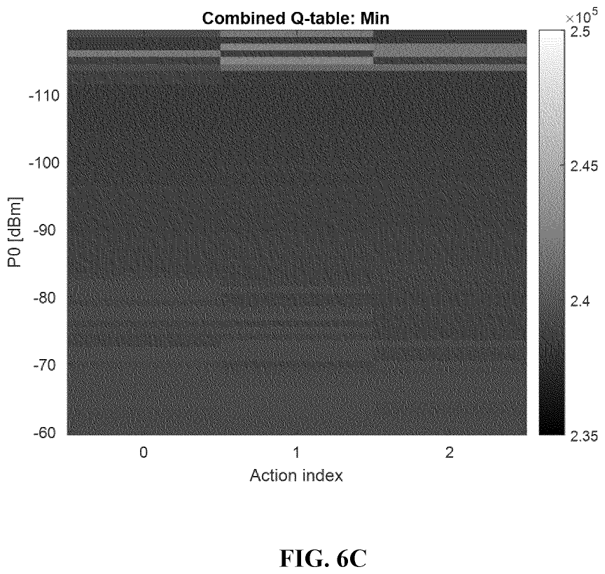

FIGS. 6A-6C graphically illustrate the results of the above-indicated simulation. More specifically, FIG. 6A shows the output Q-table of the RL agent at BS-6 after the step S204 of the method 200, while FIGS. 6B and 6C show common Q*-tables based on two different processing approaches consisting in using the average and minimum functions, respectively, in the step S208 of the method 200. In FIGS. 6B and 6C, “Average” means an average combination of Q-table entries from 21 BSs, while “Min” means a function that compares and returns the lowest value of Q-table entries from 21 BSs. The white-to-black scale shown in FIGS. 6A-6C means the following: white color (in the top) indicates the initial Q values (250000), while other gray shades up to black color indicate values which have been changed during the exploration phase. These results verify that the all the entries of common Q*-tables are filled by non-initialized constant value (250000). However, for an individual Q-table before processing, e.g., at BS-6, there is still a large range of state-action pairs which is not explored in the common Q*-table. The RL agent, therefore, has a better starting point for exploration and exploitation with the common Q*-table.

In general, the ML orchestrator entity 100 and its operation method (i.e., the method 200) may be well applied to any distributed RL/ML problem where each RL/ML agent is used in each network node (e.g., gNB). A potential example use case may also be UL radio resource allocation.

In summary, the simulation results have revealed the following:
For individual ML/RL agent at each gNB, there is only a limited range of Q (state, action) entries filled after a certain period of fast exploration, and many of them still remains the pre-initialized value before exploration.
It indeed necessitates the method 200 to properly process the Q-tables from these different ML/RL agents (as shown in FIGS. 6C and 6B, after the combination of the Q-tables into the common Q*-table, both the processing approaches, i.e., based on the average and minimum functions, could yield fully filled common Q*-tables for optimal parameter initialization at each ML/RL agent).

It should be noted that each step or operation of the method 200 and the interaction diagram 500, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processor 102. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A machine-learning (ML) orchestrator entity in a wireless communication network, comprising:
at least one processor; and
at least one memory including computer program code;
wherein the at least one memory and the computer program code are configured to,
with the at least one processor, cause the ML orchestrator entity to:
group a set of network nodes present in the wireless communication network into at least one node cluster based on at least one radio condition of a set of cells served by the set of network nodes, each network node from the set of network nodes having an ML agent installed thereon, the ML agent being configured to run based on radio measurements in a training mode and an inference mode; and
for each node cluster from the at least one node cluster:
transmit, to at least two network nodes of the node cluster, an indication to obtain a set of parameters for the ML agent by running the ML agent in the training mode;
receive the set of parameters from each of the at least two network nodes of the node cluster; and
based on the set of parameters received from each of the at least two network nodes of the node cluster, generate a common set of parameters suitable for the inference mode of the ML agents within the node cluster.

2. The ML orchestrator entity of claim 1, wherein the at least one memory and the computer program code are configured to, with the at least one processor, cause the ML orchestrator entity to receive the set of parameters from each of the at least two network nodes of the node cluster via an ML agent-specific signalling interface.

3. The ML orchestrator entity of claim 1, wherein the at least one memory and the computer program code are further configured to, with the at least one processor, cause the ML orchestrator entity to transmit a request for the set of parameters to each of the at least two network nodes of the node cluster and, in response to the request, receive the set of parameters from each of the at least two network nodes of the node cluster.

4. The ML orchestrator entity of claim 1, wherein the at least one memory and the computer program code are further configured to, with the at least one processor, cause the ML orchestrator entity to transmit the common set of parameters to each network node of the node cluster after the common set of parameters is generated.

5. The ML orchestrator entity of claim 1, wherein the at least one memory and the computer program code are further configured to, with the at least one processor, cause the ML orchestrator entity to:
receive a request for the common set of parameters from at least one network node of the node cluster; and
in response to the request, transmit the common set of parameters to each of the at least one network node of the node cluster.

6. The ML orchestrator entity of claim 4 or 5, wherein the at least one memory and the computer program code are further configured to, with the at least one processor, cause the ML orchestrator entity to transmit, together with the common set of parameters, a time instant from which the common set of parameters is to be used in the inference mode.

7. The ML orchestrator entity of claim 1, wherein the at least one memory and the computer program code are configured to, with the at least one processor, cause the ML orchestrator entity to generate the common set of parameters by using at least one of a linear function, a non-linear function, and a Boolean function.

8. The ML orchestrator entity of claim 1, wherein the ML agent is a reinforcement learning (RL) agent configured to run in an exploration mode as the training mode and in an exploitation mode as the inference mode.

9. The ML orchestrator entity of claim 8, wherein the RL agent is based on a Q-learning approach, and the set of parameters from each of the at least two network nodes of the node cluster is presented as a Q-table, and wherein the at least one memory and the computer program code are configured to, with the at least one processor, cause the ML orchestrator entity to generate the common set of parameters as a common Q-table.

10. A method for operating a machine-learning (ML) orchestrator entity in a wireless communication network, said method comprising: grouping a set of network nodes present in the wireless communication network into at least one node cluster based on at least one radio condition of a set of cells served by the set of network nodes, each network node from the set of network nodes having an ML agent installed thereon, the ML agent being configured to run based on radio measurements in a training mode and an inference mode; and for each node cluster from the at least one node cluster:
transmitting, to at least two network nodes of the node cluster, an indication to obtain a set of parameters for the ML agent by running the ML agent in the training mode;
receiving the set of parameters from each of the at least two network nodes of the node cluster; and
based on the set of parameters received from each of the at least two network nodes of the node cluster, generating a common set of parameters suitable for the inference mode of the ML agents within the node cluster.

11. The method of claim 10, wherein the set of parameters is received from each of the at least two network nodes of the node cluster via an ML agent-specific signalling interface.

12. The method of claim 10, wherein said receiving comprises:
transmitting a request for the set of parameters to each of the at least two network nodes of the node cluster; and
in response to the request, receiving the set of parameters from each of the at least two network nodes of the node cluster.

13. The method of claim 10, further comprising transmitting the common set of parameters to each network node of the node cluster after the common set of parameters is generated.

14. The method of claim 10, further comprising:
receiving a request for the common set of parameters from at least one network node of the node cluster; and
in response to the request, transmitting the common set of parameters to each of the at least one network node of the node cluster.

15. The method of claim 13, further comprising transmitting, together with the common set of parameters, a time instant from which the common set of parameters is to be used in the inference mode.

16. The method of claim 10, wherein said generating comprises generating the common set of parameters by using at least one of a linear function, a non-linear function, and a Boolean function.

17. The method of claim 10, wherein the ML agent is a reinforcement learning (RL) agent configured to run in an exploration mode as the training mode and in an exploitation mode as the inference mode.

18. The method of claim 17, wherein the RL agent is based on a Q-learning approach, and the set of parameters from each of the at least two network nodes of the node cluster is presented as a Q-table, and wherein said generating comprises generating the common set of parameters as a common Q-table.

19. A non-transitory computer-readable storage medium having a computer program comprising computer code encoded thereon, wherein the computer code, when executed by at least one processor, causes the at least one processor to perform the method according to claim 10.
